(19) United States
(12) Patent Application Publication
(10) Pub. No.: US 2026/0020055 A1
(43) Pub. Date: Jan. 15, 2026

(54) METHOD AND APPARATUS OF COT SHARING FOR SIDELINK GROUPCAST

(71) Applicant: LENOVO (BEIJING) LIMITED, Beijing (CN)

(72) Inventors: Xiaodong YU, Beijing (CN); Zhennian SUN, Beijing (CN); Haipeng LEI, Beijing (CN); Yu ZHANG, Beijing (CN); Xin GUO, Beijing (CN)

(21) Appl. No.: 18/993,848

(22) PCT Filed: Jul. 14, 2022
(86) PCT No.: PCT/CN2022/105718

§ 371 Date: Jan. 13, 2025

(51) Int. Cl. H04W 74/0808; H04W 72/25

(52) U.S. Cl. CPC H04W 74/0808; H04W 72/25

(57) ABSTRACT

Embodiments of the present disclosure relate to methods and apparatuses of a channel occupancy time (COT) sharing mechanism for a sidelink groupcast. According to some embodiments of the disclosure, a user equipment (UE) may include a transceiver; and a processor coupled to the transceiver. The processor may be configured to: initialize a channel occupancy time (COT) corresponding to a channel access priority class (CAPC) level or a traffic priority level; and transmit at least one of sidelink control information (SCI) or a data transmission associated with the SCI on a sidelink during first channel occupancy duration of the COT, wherein the SCI includes frequency and time resource indication information.

### TECHNICAL FIELD

Embodiments of the present disclosure generally relate to wireless communication technology, and more particularly to a channel occupancy time (COT) sharing mechanism for a sidelink groupcast.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum.

There is a need for providing a COT sharing mechanism for a sidelink groupcast.

### SUMMARY

Some embodiments of the present disclosure provide a user equipment (UE). The UE may include: a transceiver; and a processor coupled to the transceiver. The processor may be configured to: initialize a channel occupancy time (COT) corresponding to a channel access priority class (CAPC) level or a traffic priority level; and transmit at least one of sidelink control information (SCI) or a data transmission associated with the SCI on a sidelink during first channel occupancy duration of the COT, wherein the SCI includes frequency and time resource indication information.

In some embodiments, the frequency and time resource indication information includes at least one of: first information indicating one or more frequency resources assigned for the UE and one or more member UEs in a groupcast group, wherein the at least one of the SCI or the data transmission is transmitted on the one or more frequency resources; or second information indicating remaining channel occupancy duration of the COT for the one or more member UEs; or third information indicating time duration of the COT and one or more time slots used by the UE within the time duration of the COT.

In some embodiments, the first information includes one of: one or more indexes of the one or more frequency resources; a field in a bitmap manner associated with the one or more frequency resources; a starting point and an ending point in a frequency domain associated with the one or more frequency resources; and a starting point and a length in the frequency domain associated with the one or more frequency resources.

In some embodiments, the SCI further includes at least one of: a first indicator indicating a total number of one or more frequency resources that can be used by each member UE in a groupcast group within time duration of the COT or remaining channel occupancy duration of the COT; or a second indicator indicating a total number of one or more time slots that can be used by the each UE within the time duration of the COT or the remaining channel occupancy duration of the COT.

In some embodiments, at least one of the first indicator or the second indicator is associated with a group identifier (ID) of the groupcast group.

In some embodiments, the SCI includes a first stage SCI and a second stage SCI, wherein the first stage SCI indicate a format of the second stage SCI, and wherein the second stage SCI includes the at least one of the first indicator or the second indicator.

In some embodiments, the processor of the UE is configured to exchange higher layer information with one or more member UEs in a groupcast group, and wherein the higher layer information includes at least one of buffer status report (BSR) information, ID information of the one or more member UEs in the groupcast group, or a total number of the one or more member UEs in the groupcast group.

In some embodiments, the processor of the UE is configured to: determine, based on the higher layer information, whether a first time slot within time duration of the COT or remaining channel occupancy duration of the COT includes no data transmission from the one or more member UEs; transmit a reservation transmission in the first time slot, in response to determining that the first time slot includes no data transmission from the one or more member UEs.

In some embodiments, the SCI further includes an offset indicator associated with a member ID of each member UE in a groupcast group, and wherein one or more frequency resources that can be used by the each UE is determined based at least in part on the offset indicator.

In some embodiments, the processor of the UE is configured to: perform a sensing operation to detect a transmission at a second time slot within time duration of the COT or remaining channel occupancy duration of the COT; and transmit a reservation transmission in the second time slot, in response to detecting that the second time slot includes no transmission.

In some embodiments, the sensing operation is performed on first time duration at a beginning of the second time slot, and wherein the reservation transmission is transmitted on subsequent time duration within the second time slot.

In some embodiments, the sensing operation is a listen-before-talk (LBT) type 2.

In some embodiments, the reservation transmission is transmitted on at least one frequency resource within one or more frequency resources assigned for the UE and one or more member UEs in a groupcast group.

In some embodiments, the one or more frequency resources include at least one of: one or more physical resource blocks (PRB)s; one or more interlaces; or one or more subchannels.

Some embodiments of the present disclosure provide a user equipment (UE). The UE may include: a transceiver; and a processor coupled to the transceiver. The processor may be configured to receive at least one of sidelink control information (SCI) or a data transmission associated with the SCI on a sidelink during first channel occupancy duration of a channel occupancy time (COT), wherein the SCI includes frequency and time resource indication information, and wherein the COT corresponding to a channel access priority class (CAPC) level or a traffic priority level is initiated by a second UE.

In some embodiments, the frequency and time resource indication information includes at least one of: first information indicating one or more frequency resources assigned for the second UE and one or more member UEs in a groupcast group, wherein the one or more member UEs include the first UE, and wherein the at least one of the SCI or the data transmission is transmitted on the one or more frequency resources; or second information indicating remaining channel occupancy duration of the COT for the one or more member UEs; or third information indicating time duration of the COT and one or more time slots used by the UE within the time duration of the COT.

In some embodiments, the first information includes one of: one or more indexes of the one or more frequency resources; and a field in a bitmap manner associated with the one or more frequency resources; a starting point and an ending point in a frequency domain associated with the one or more frequency resources; and a starting point and a length in the frequency domain associated with the one or more frequency resources.

In some embodiments, the processor of the first UE is configured to allocate a resource index to each of the one or more frequency resources within the time duration of the COT or the remaining channel occupancy duration of the COT.

In some embodiments, the processor of the first UE is configured to receive at least one of: a first indicator indicating a total number of one or more frequency resources that can be used by each UE in the groupcast group within time duration of the COT or remaining channel occupancy duration of the COT; or a second indicator indicating a total number of one or more time slots that can be used by the each UE within the time duration of the COT or the remaining channel occupancy duration of the COT.

In some embodiments, the one or more frequency resources include at least one of: one or more physical resource blocks (PRB)s; one or more interlaces; or one or more subchannels.

In some embodiments, at least one of the first indicator or the second indicator is associated with a group identifier (ID) of the groupcast group.

In some embodiments, the at least one of the first indicator or the second indicator is included in: higher layer signalling pre-configured or configured to the first UE; or the SCI received from the second UE.

In some embodiments, the SCI includes a first stage SCI and a second stage SCI, wherein the first stage SCI indicate a format of the second stage SCI, and wherein the second stage SCI includes the at least one of the first indicator or the second indicator.

In some embodiments, the processor of the first UE is configured to determine a set of resources to be used by the first UE within the time duration of the COT or the remaining channel occupancy duration of the COT based on a set of parameters, and wherein the set of parameters include at least one of: a member ID of the first UE; a total number of one or more member UEs in a groupcast group; the first indicator; or the second indicator.

In some embodiments, the processor of the first UE is configured to exchange higher layer information with the second UE, and wherein the higher layer information includes at least one of buffer status report (BSR) information, ID information of the one or more member UEs in the groupcast group, or a total number of the one or more member UEs in the groupcast group.

In some embodiments, the SCI further includes an offset indicator associated with a member ID of each UE in the groupcast group.

In some embodiments, the set of parameters further include the offset indicator.

In some embodiments, to determine the set of resources, the processor of the first UE is configured to calculate a location of the set of resources in a frequency domain based on the set of parameters. To calculate the location of the set of resources, the processor of the first UE is configured to calculate at least one of: a minimum resource index corresponding to the set of resources; or a maximum resource index corresponding to the set of resources.

In some embodiments, in response to determining that a resource index of one frequency resource calculated based on the set of parameters is greater than a maximum resource index corresponding to all of one or more frequency resources within the time duration of the COT or the remaining channel occupancy duration of the COT, the set of resources do not include the one frequency resource.

In some embodiments, the processor of the first UE is configured to transmit data on at least one frequency resource within the set of resources.

Some embodiments of the present disclosure provide a method for wireless communication performed by a user equipment (UE). The method may include: initializing a channel occupancy time (COT) corresponding to a channel access priority class (CAPC) level or a traffic priority level; and transmitting at least one of sidelink control information (SCI) or a data transmission associated with the SCI on a sidelink during first channel occupancy duration of the COT, wherein the SCI includes frequency and time resource indication information.

Some embodiments of the present disclosure provide a method for wireless communication performed by a user equipment (UE). The method may include: receiving at least one of sidelink control information (SCI) or a data transmission associated with the SCI on a sidelink during first channel occupancy duration of a channel occupancy time (COT), wherein the SCI includes frequency and time resource indication information, and wherein the COT with a channel access priority class (CAPC) level is initiated by a second UE.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIG. 2 illustrates a flowchart of an exemplary procedure of initializing a COT in accordance with some embodiments of the present disclosure.

FIGS. 3-7 illustrate exemplary sidelink transmissions in a COT in accordance with some embodiments of the present disclosure.

FIG. 8 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

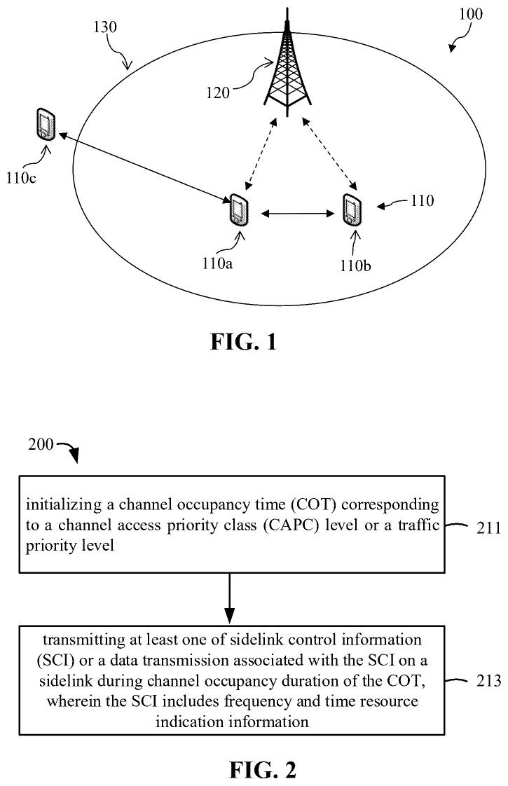

FIG. 1 illustrates a schematic diagram of a wireless communication system 100 in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

In some embodiments of the present disclosure, sidelink transmission may be performed on an unlicensed spectrum. When an unlicensed spectrum is used for sidelink transmissions, a channel access procedure (also known as a listen-before-talk (LBT) test or LBT procedure) is required before any sidelink transmission. Two types of channel access procedures, i.e., LBT type 1 and LBT type 2 are supported.

For an unlicensed spectrum, by performing LBT type 1, a UE can obtain channel occupancy (CO) and occupy the channel until the maximum channel occupancy time (MCOT). For example, the MCOT may be related to a channel access priority class (CAPC) value for downlink (DL) as shown in below Table 1, or may be related to a channel access priority class (CAPC) value for uplink (UL) as shown in below Table 2. It should be understood that Table 1 or Table 2 is only for illustrative purposes, and should not be construed as limiting the embodiments of the present disclosure.

TABLE 1
Channel Access Priority Class (CAPC) for DL

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, 255, |
| | | | | 10 ms | 511, 1023} |

TABLE 2
Channel Access Priority Class (CAPC) for UL

| Channel | | | | | |
|---|---|---|---|---|---|
| Access | | | | | |
| Priority | | | | | |
| Class (p) | mₚ | CW_{min, p} | CW_{max, p} | T_{ulmcot, p} | allowed CWₚsizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE 1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms, it may be increased to 8 ms by inserting one or more gaps. The minimum duration of a gap shall be 100 μs. The maximum duration before including any such gap shall be 6 ms.

For instance, according to Table 2, when a UE performs a successful LBT type 1, the UE can occupy the channel at a maximum of 2 ms, 4 ms, 6 ms or 10 ms, depending on the corresponding CAPC value which is determined based on the traffic priority. The higher the CAPC value is, the longer the MCOT on the unlicensed spectrum is. As shown in Table 2, for CAPC value of 3 or 4, the MCOT can be 10 ms, which is equivalent to 10 slots in the case of 15 kHz subcarrier spacing, 20 slots in the case of 30 kHz subcarrier spacing, 40 slots in the case of 60 kHz subcarrier spacing, or 80 slots in the case of 120 kHz subcarrier spacing.

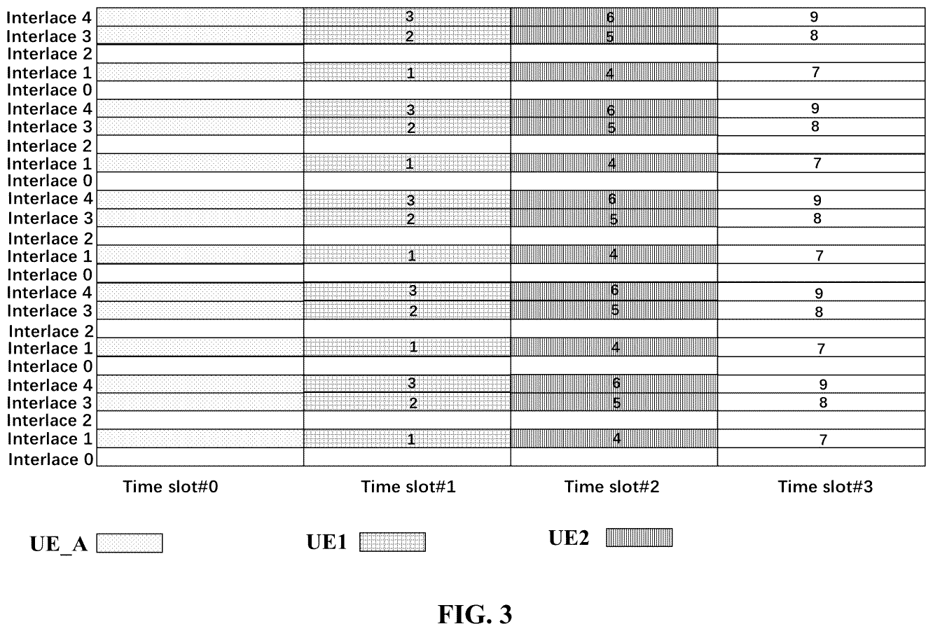

According to agreements of 3GPP standard document, for 15 kHz SCS (subcarrier spacing), 20 Mhz bandwidth comprises 10 interlaces with 10 PRBs or 11 PRBs per interlace. For 30 kHz SCS (subcarrier spacing), 20 Mhz bandwidth comprises 5 interlaces with 10 PRBs or 11 PRBs per interlace. FIGS. 3-7 refer to embodiments of 5 interlaces in frequency domain for 30 kHz SCS and 20 Mhz bandwidth, which are only for illustrative purposes and should not be construed as limiting the embodiments of the present disclosure.

In general, a COT sharing mechanism may be defined on a DL or a UL. In sidelink (SL) communication mode 2, a COT initiator UE may initialize a COT based on its traffic and the traffic priority (CAPC), and the COT size (time duration) is associated with CAPC value. If the COT initiator UE only uses a part of the COT, the remaining part of the COT can be shared to another UE, i.e., a COT shared UE. In addition, based on the regulation, the destination UE of a COT shared UE should be a COT initiator UE. A COT initiator UE may indicate COT related information in SCI, e.g., the remaining channel occupancy duration of the COT similar as Uu link DCI. The COT shared UE may determine whether to be shared the COT based on the SCI, which includes the remaining channel occupancy duration of the COT and ID information.

Currently, following issues need to be addressed. For SL communication mode 1, a COT sharing mechanism can be assisted with a BS scheduling based resource allocation. For SL communication mode 2, i.e., UE-to-UE COT sharing without a BS's assistance has not been studied. Various cast types may be supported for SL communication, i.e., unicast, groupcast and broadcast. For unicast, a UE can provide ID related information (e.g., a source ID and a destination) and COT related information (e.g., the remaining channel occupancy duration) for sharing its initialized COT. Because there is only one reception UE of unicast transmission, the reception UE can determine the shared resource based on the resource allocation indication information, ID related information (source ID and destination), and COT related information. But for groupcast, with considering the limited payload size of SCI and large amount of COT sharing assistance information (i.e., potential multiple sets of “the resource allocation indication information, ID related information (e.g., source ID and destination), and COT related information”), how to share the COT to multiple UEs (i.e., multiple group member UEs) on orthogonal time or frequency resource(s) respectively has not been studied.

Embodiments of the present disclosure provide solutions aim to solve the above issues. For example, some embodiments of the present disclosure define two indicators. One indicator is used to indicate the frequency resource size for each COT shared UE. For example, the unit of this indicator may be a total number of PRB(s), a total number of interlace(s), or a total number of subchannel(s). Another indicator is used to indicate a total number of time slot(s) within the COT duration or remaining channel occupancy duration for each COT shared UE. These two indicators can be (pre-) configured or indicated by higher layer signalling or can be included in sidelink control information (SCI) of a COT initiator UE.

In some embodiments of the present disclosure, a UE (e.g., a COT shared UE) determines an index of interlace (e.g., j) and an index of time slot (e.g., i) for PSCCH or PSSCH transmission corresponding to a shared resource based on its (pre-) configured member ID (e.g., M_ID) index (e.g., m) and/or a maximum number (e.g., M) of member UEs in a groupcast group.

More details on the embodiments of the present disclosure will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 2 illustrates a flowchart of an exemplary procedure 200 of initializing a COT in accordance with some embodiments of the present disclosure. Details described in all of other embodiments of the present disclosure are applicable for the embodiments shown in FIG. 2. In some examples, the procedure may be performed by a COT initiator UE, for example, UE 110a in FIG. 1.

In the exemplary procedure 200, in operation 211, a UE (e.g., UE 110a in FIG. 1) may initialize a COT corresponding to a CAPC level or a traffic priority level. For instance, the UE may be named as “a COT initiator UE” or the like.

In operation 213, the UE may transmit at least one of sidelink control information (SCI) or a data transmission associated with the SCI on a sidelink during channel occupancy duration of the COT. Time duration of the COT includes “channel occupancy duration of the COT” which is used by the UE (i.e., a COT initiator UE) and “remaining channel occupancy duration of the COT” which may be shared by member UE(s) in a groupcast group (i.e., COT shared UE(s)). Member UE(s) may be named as “COT shared UE(s)” or the like.

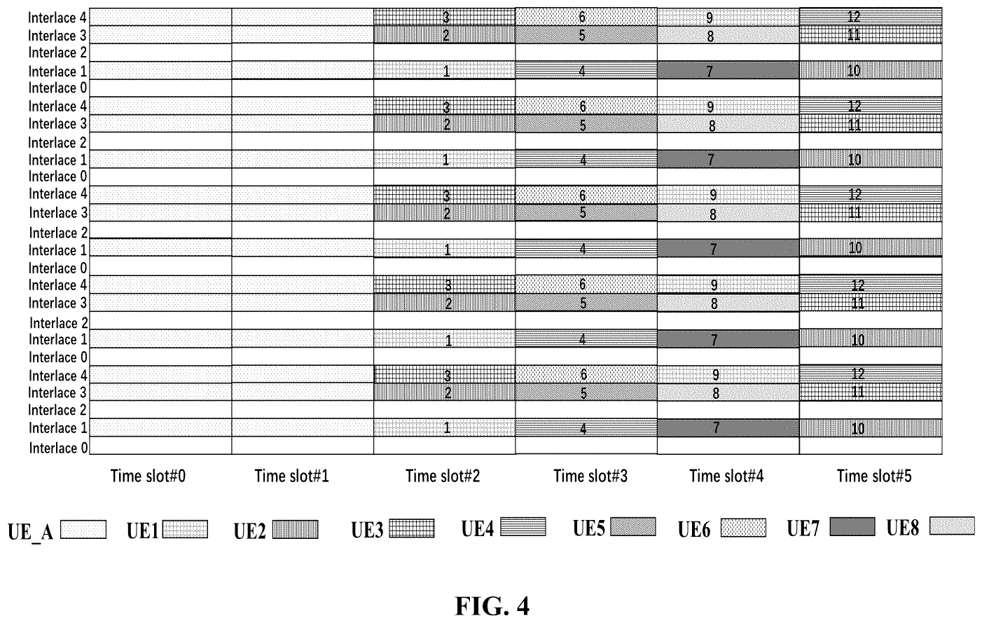

The SCI transmitted in operation 213 may include frequency and time resource indication information. In some embodiments, the frequency and time resource indication information includes at least one of:
(1) Information indicating frequency resource(s) assigned for the UE and member UE(s) (e.g., UE 110b and/or UE 110c in FIG. 1) in a groupcast group (denoted as “information #1” for simplicity). For example, information #1 indicates “frequency resource assignment” described in the embodiments of any of FIGS. 3 and 4. At least one of the SCI or the data transmission may be transmitted on the frequency resource(s). In an embodiment, the frequency resource(s) includes at least one of: PRB(s); interlace(s); or subchannel(s).
(2) Information indicating remaining channel occupancy duration of the COT for the member UE(s) (denoted as “information #2” for simplicity). For example, information #2 indicates “remaining channel occupancy duration of the COT” described in the embodiments of any of FIGS. 3 and 4.
(3) Information indicating time duration of the COT and time slot(s) used by the UE within the time duration of the COT (denoted as “information #3” for simplicity).

In some embodiments, information #1 includes one of:
(1) One or more indexes of the frequency resource(s) assigned for the UE and the member UE(s). For example, the frequency resource(s) (or their indexes) is assigned continuously in frequency domain.
(2) A field in a bitmap manner associated with the frequency resource(s).
(3) A starting point and an ending point in a frequency domain associated with the frequency resource(s). For example, the starting point can be the lowest index of the frequency resource(s), and the ending point can be the higher index of the frequency resource(s).
(4) A starting point and a length in frequency domain associated with the frequency resource(s). For example, the length is a total number of the frequency resource(s).

In some embodiments, the SCI further includes at least one of:
(1) An indicator (denoted as “indicator #1” for simplicity) indicating a total number of frequency resource(s) that can be used by each member UE in a groupcast group within “time duration of the COT” or “remaining channel occupancy duration of the COT”. For example, indicator #1 is “j_interlace” described in the embodiments of any of FIGS. 3 and 4.
(2) An indicator (denoted as “indicator #2” for simplicity) indicating a total number of time slot(s) that can be used by the each UE within “time duration of the COT” or “remaining channel occupancy duration of the COT”. For example, indicator #2 is “i_slot” described in the embodiments of any of FIGS. 3 and 4.

In some embodiments, at least one of indicator #1 or indicator #2 is associated with a group ID of the groupcast group.

In some embodiments, the SCI includes a first stage SCI and a second stage SCI. The first stage SCI indicates a format of the second stage SCI. The second stage SCI includes at least one of indicator #1 or indicator #2.

In some embodiments, the UE may exchange higher layer information with member UE(s) in a groupcast group. The higher layer information includes at least one of: BSR information, ID information of the member UE(s) in the groupcast group, or a total number of the member UE(s) in the groupcast group.

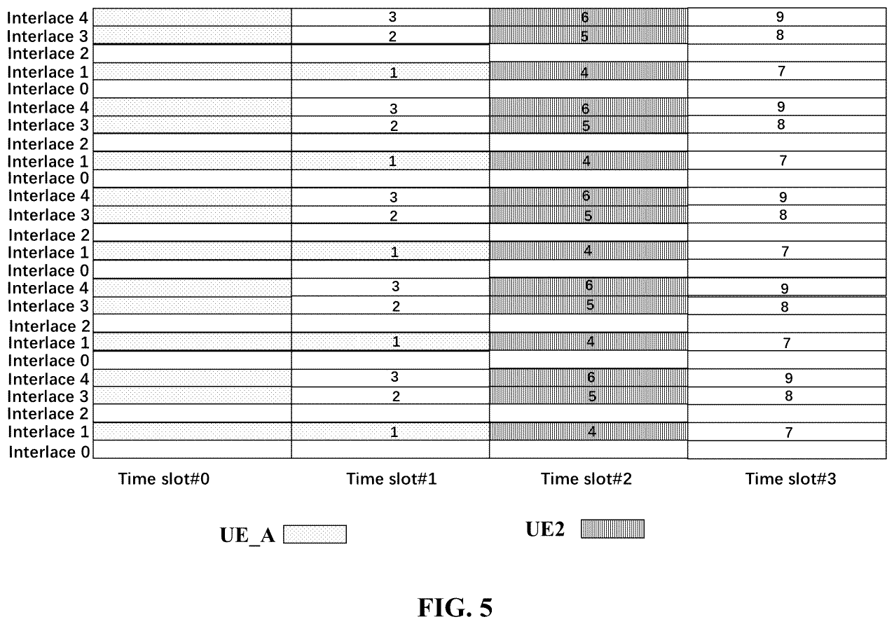

In some embodiments, based on the higher layer information, the UE may determine whether a time slot (e.g., “Time slot #1” as shown in FIG. 5) within “time duration of the COT” or “remaining channel occupancy duration of the COT” includes no data transmission from the member UE(s). In response to determining that the time slot includes no data transmission, the UE may transmit a reservation transmission in the time slot (e.g., “Time slot #1” as shown in FIG. 5). A specific example is described in the embodiments of FIG. 5.

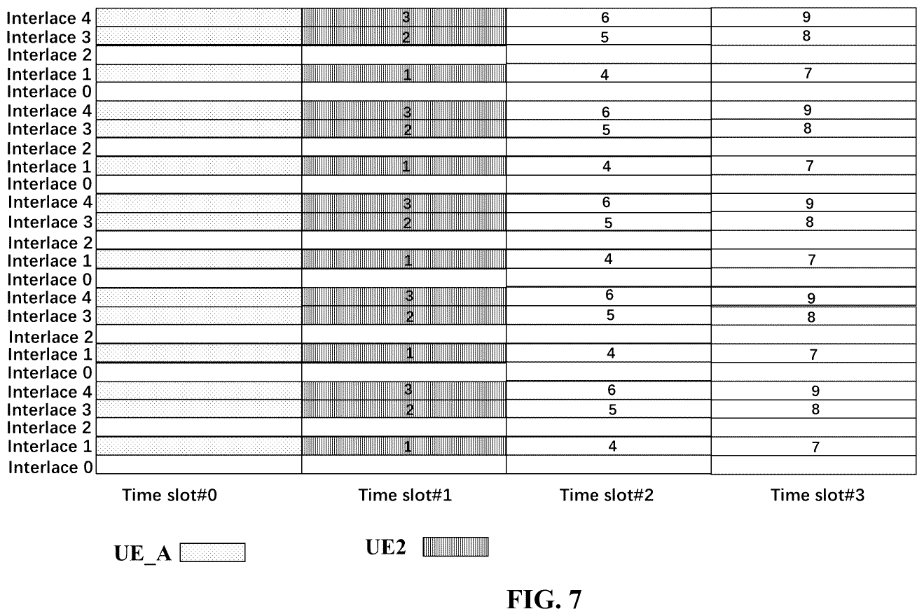

In some embodiments, the SCI further includes an offset indicator associated with a member ID of each member UE in a groupcast group. Frequency resource(s) that can be used by the each UE is determined based at least in part on the offset indicator (e.g., M_ID_offset as shown in FIG. 7). A specific example is described in the embodiments of FIG. 7.

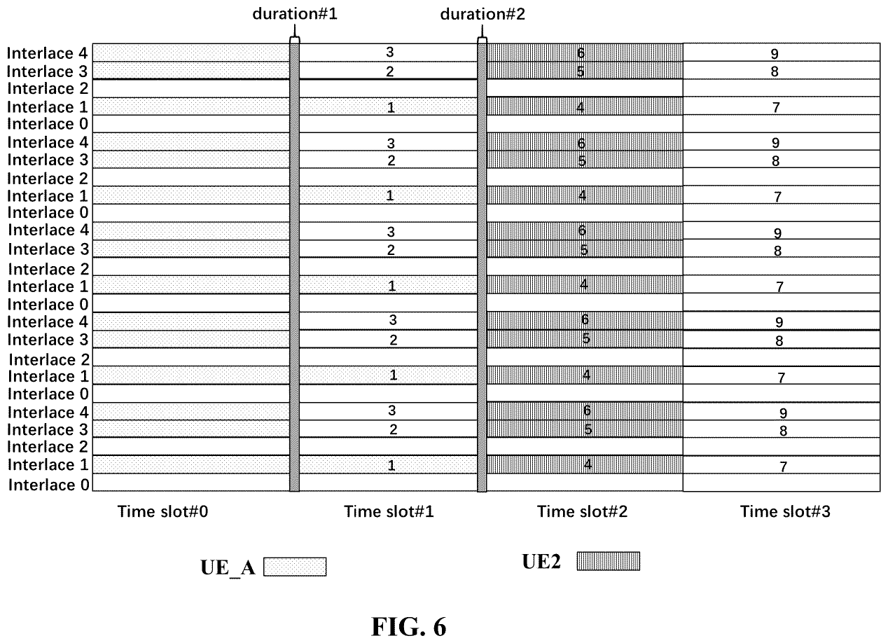

In some embodiments, the UE may perform a sensing operation to detect a transmission at a time slot (e.g., “Time slot #1” as shown in FIG. 6) within “time duration of the COT” or “remaining channel occupancy duration of the COT”. For instance, if the detected energy is lower than a (pre-) configured energy detection threshold, the UE detects that the time slot includes no transmission. In response to detecting that the time slot includes no transmission, the UE may transmit a reservation transmission in the time slot.

In an embodiment, the sensing operation is performed on time duration at a beginning of the time slot (e.g., “Time slot #1” as shown in FIG. 6), e.g., on the full or partial of the first symbol at the beginning of the time slot. The reservation transmission is transmitted on subsequent time duration within the time slot. The sensing operation can be a LBT operation, i.e., sensing based energy detection. For instance, the sensing operation is a LBT type 2. A specific example is described in the embodiments of FIG. 6.

In some embodiments, the reservation transmission is transmitted on at least one frequency resource within frequency resource(s) assigned for the UE and member UE(s) in a groupcast group. In an embodiment, the frequency resource(s) includes at least one of: PRB(s); interlace(s); or subchannel(s).

It should be appreciated by persons skilled in the art that the sequence of the operations in exemplary procedure 200 may be changed and some of the operations in exemplary procedure 200 may be eliminated or modified, without departing from the spirit and scope of the disclosure.

In addition, some embodiments of the present disclosure provide an exemplary procedure of a UE receiving SCI during a COT. Although described with respect to a UE, it should be understood that other devices may be configured to perform a similar procedure. In some examples, the procedure may be performed by a COT shared UE, for example, UE 110b in FIG. 1.

It should be appreciated by persons skilled in the art that the sequence of the operations in this exemplary procedure of a UE may be changed and some of the operations in this exemplary procedure may be eliminated or modified, without departing from the spirit and scope of the disclosure. Details described in all other embodiments of the present application, e.g., in the embodiments of FIGS. 2-8 are applicable for this exemplary procedure. Moreover, details described in this exemplary procedure are applicable for all the embodiments of FIGS. 1-8.

In particular, in this exemplary procedure, a UE (e.g., UE 110b in FIG. 1) may receive at least one of SCI or a data transmission associated with the SCI on a sidelink during channel occupancy duration of a COT. The COT corresponding to a CAPC level or a traffic priority level is initiated by another UE. The SCI includes frequency and time resource indication information. All the above details regarding SCI transmitted by a UE (e.g., a COT initiator UE) and frequency resource(s) assigned for the UE and member UE(s) (e.g., COT shared UE(s)) in a groupcast group may apply here.

In some embodiments, the UE may allocate a resource index to each of the frequency resource(s) within the time duration of the COT or the remaining channel occupancy duration of the COT.

In some embodiments, the UE may receive at least one of:
(1) an indicator (denoted as “indicator #1” for simplicity) indicating a total number of frequency resource(s) that can be used by each UE in the groupcast group within the time duration of the COT or the remaining channel occupancy duration of the COT; or
(2) an indicator (denoted as “indicator #2” for simplicity) indicating a total number of time slot(s) that can be used by the each UE within the time duration of the COT or the remaining channel occupancy duration of the COT.

In some embodiments, at least one of indicator #1 or indicator #2 is associated with a group ID of the groupcast group. In some embodiments, at least one of indicator #1 or indicator #2 is included in: higher layer signalling pre-configured or configured to the UE (i.e., a COT shared UE); or the SCI received from another UE (i.e., a COT initiator UE).

In some embodiments, the UE may determine a set of resources to be used by the UE within the time duration of the COT or the remaining channel occupancy duration of the COT based on a set of parameters. The set of parameters may include at least one of:
(1) a member ID of the UE, e.g., “m” described in the embodiments of any of FIGS. 3 and 4;
(2) a total number of member UE(s) in a groupcast group, e.g., “M” described in the embodiments of any of FIGS. 3 and 4;
(3) indicator #1, e.g., “j_interlace” described in the embodiments of any of FIGS. 3 and 4; or
(4) indicator #2, e.g., “i_slot” described in the embodiments of any of FIGS. 3 and 4.

In some embodiments, the UE may exchange higher layer information with another UE (e.g, a COT initiator UE). The higher layer information includes at least one of: BSR information, ID information of the member UE(s) in the groupcast group, or a total number of the member UE(s) in the groupcast group. In an embodiment, the SCI further includes an offset indicator associated with a member ID of each UE in the groupcast group. The set of parameters may further include the offset indicator. A specific example is described in the embodiments of FIG. 7.

In some embodiments, to determine the set of resources, the UE may calculate a location of the set of resources in a frequency domain based on the set of parameters. To calculate the location of the set of resources, the UE may calculate at least one of:
(1) a minimum resource index corresponding to the set of resources; or
(2) a maximum resource index corresponding to the set of resources.

In an embodiment, the UE only calculates the minimum resource index. An ending location of the set of resources in frequency domain may be calculated based on “a sum of the minimum resource index and indicator #1 (e.g., “j_interlace” described in the embodiments of any of FIGS. 3 and 4)” minus 1. In a further embodiment, the UE only calculates the maximum resource index. A starting location of the set of resources in the frequency domain may be calculated based on “a difference of the maximum resource index and indicator #1 (e.g., “j_interlace” described in the embodiments of any of FIGS. 3 and 4)” plus 1. In another embodiment, the UE calculates both the minimum resource index and the maximum resource index, as starting and ending locations of the set of resources in frequency domain.

In some embodiments, in response to determining that a resource index (e.g., the minimum resource index or the maximum resource index) of one frequency resource (e.g., frequency resource #1) calculated based on the set of parameters is greater than “a maximum resource index corresponding to all of frequency resource(s) within the time duration of the COT or the remaining channel occupancy duration of the COT”, the set of resources do not include frequency resource #1. That is, the UE cannot transmit data on frequency resource #1. A specific example is described in the embodiments of FIG. 4.

In some embodiments, the UE may transmit data on at least one frequency resource within the set of resources. That is, the UE may transmit data on full or partial of the set of resources. A specific example is described in the embodiments of any of FIGS. 5 and 6.

According to some embodiments of the present disclosure, a UE (e.g., a COT initiator UE) and another UE (e.g., a COT shared UE) are (pre-) configured or indicated by higher layer signalling as a group for a groupcast transmission on a sidelink. The group related information includes at least one of M_ID (member ID) index “m” or a maximum number of member UEs “M” in the groupcast group.

According to some embodiments of the present disclosure, a COT initiator UE initializes a COT with a certain CAPC level and performs a (groupcast) transmission on a sidelink during this COT duration. The transmission includes SCI and its associated data transmission. The SCI may include indication information of “frequency resource assignment” of the groupcast transmission (e.g., information #1), “remaining channel occupancy duration” of the initialized COT (e.g., information #2), and/or “time duration of the COT” and “time slot(s) used by a COT shared UE within the time duration of the COT” (e.g., information #3).

The SCI may further include at least one indicator, e.g., indicator #1 and/or indicator #2. Indicator #1 (e.g., “j_interlace”) may be used to indicate a frequency resource size for a transmission for each time of each COT shared UE. The transmission for each time of each COT shared UE can be allocated one or more time slots. A unit of indicator #1 can be a total number of PRB(s), a total number of interlace(s), or a total number of subchannel(s). Indicator #2 (e.g., “i_slot”) may be used to indicate a total number of time slot(s) within the COT duration or remaining channel occupancy duration for each COT shared UE.

In some embodiments, indicator #1 and indicator #2 may be included in the second stage SCI. An indicator in the first stage SCI is used to indicate the format of the second stage SCI. That is, the second stage SCI may be the format for the COT initiator UE or the format for the COT shared UE. Indicator #1 and indicator #2 may be included or not included in the second stage SCI received by the COT shared UE from the COT initiator UE.

According to some embodiments of the present disclosure, a COT shared UE may receive a (groupcast) transmission on a sidelink including the abovementioned indication information from a COT initiator UE, e.g., “frequency resource assignment” of the groupcast transmission and “remaining channel occupancy duration” of the initialized COT.

A COT shared UE is provided a set of resources (e.g., PRB(s), interlace(s), or subchannel(s)) for PSCCH/PSSCH transmission within a shared COT in a resource pool. For a number of frequency resource(s) (e.g., PRB(s), interlace(s), or subchannel(s)) provided by indication information of “frequency resource assignment” from the COT initiator UE, and a number of PSCCH/PSSCH slots provided by indication information of “remaining channel occupancy duration” from the COT initiator UE, the COT shared UE may allocate a set of resource(s) with a total number of [j_interlace*interlace_size (e.g., number of PRB(s) in one interlace)*i_slot] from resource(s) with a total number of [frequency resource assignment*remaining channel occupancy duration]. That is, all of resources assigned to the COT initiator UE and the COT shared UE(s) can be calculated by a product of “frequency resource assignment” and “remaining channel occupancy duration”. The set of resources which can be used by the COT shared UE(s) within all the resources may be calculated by a product of “j_interlace”, “interlace_size”, and “i_slot”.

In some embodiments, “j_interlace” is the (maximum) number of frequency resources (e.g., interlace(s)) for a transmission for each time of a UE; and “i_slot” is the (maximum) number of time slot(s) for the UE within remaining channel occupancy duration of the initialized COT. The transmission for each time of the UE can be allocated one or more time slots. Indicators “j_interlace” and “i_slot” may be provided by the COT initiator UE or by higher layer signalling. The “j_interlace” and “i_slot” can be (pre-) configured per a groupcast group and may be associated with a group ID (source or destination ID) of the groupcast group. For example, “j_interlace” and “i_slot” may be (pre-) configured with different values for different groupcast groups.

In some embodiments, a COT shared UE determines an index of frequency resource (e.g., interlace) “j” and an index of time slot “i” for PSCCH/PSSCH transmission corresponding to a shared resource based on its (pre-) configured M_ID (member ID) index “m” and/or a maximum number of member UE(s) “M”. For instance, 0=<j=<frequency resource assignment. 0=<i=<remaining channel occupancy duration.

In some embodiments, a set of resources which can be used by the COT shared UE within the shared COT may be calculated by Equation (1):

$$j = [ ( m - 1 + M * ( i\_slot - 1 ) ) * j\_interlace + 1 , ( m + M * ( i\_slot - 1 ) ) * j\_interlace ] \qquad Equation ( 1 )$$

wherein:
   j is an index range of the set of resources for a UE;
   j_interlace is a maximum number of frequency resource(s) for a transmission for each time of the UE, and the transmission for each time of the UE can be allocated one or more time slots;
   i_slot is a maximum number of time slot(s) for the UE within remaining channel occupancy duration of the initialized COT, and 0<i_slot=<i;
   m is a (pre-) configured M_ID (member ID) index; and
   M is a maximum total number of member UEs in the groupcast group.

As shown in Equation (1), within the index range of the set of resources for the UE, a minimum resource index corresponding to the set of resources (e.g., interlace(s)) may be calculated as “(m−1+M*(i_slot−1))*j_interlace+1”. A maximum resource index corresponding to the set of resources may be calculated as “(m+M*(i_slot−1))*j_interlace”.

In an embodiment, if i_slot=1, Equation (1) may be simplified as:

$$j = [ ( m - 1 ) * j\_interlace + 1 , m * j\_interlace ]$$

In a further embodiment, if i_slot=2, Equation (1) may be simplified as:

$$j = [ ( m - 1 ) * j\_interlace + 1 , m * j\_interlace ] and j = [ ( m - 1 + M ) * j\_interlace + 1 , ( m + M ) * j\_interlace ]$$

That is, when i_slot=2, j should be calculated twice via Equation (1), including: i_slot=1 for a transmission for the first time of the UE, and i_slot=2 for a transmission for the second time of the UE. Similarly, when i_slot=3, j should be calculated three times via Equation (1), including: i_slot=1, i_slot=2, and i_slot=3, for transmissions for the first, second, and third times for the UE, respectively.

FIG. 3 illustrates exemplary sidelink transmissions in a COT in accordance with some embodiments of the present disclosure. The embodiments of FIG. 3 assume that there are 5 interlaces (denoted as Interlace 0 to Interlace 4) in frequency domain. In some other embodiments, there may be 10 interlaces in frequency domain, without departing from the spirit and scope of the disclosure. The embodiments of FIG. 3 assume that interlaces in frequency domain are assigned to UEs. Other embodiments of FIG. 3 may refer to other type of resources (e.g., PRB(s) or subchannel(s)), without departing from the spirit and scope of the disclosure. Details described in all of other embodiments of the present disclosure are applicable for the embodiments shown in FIG. 3.

As shown in FIG. 3, UE_A, UE1, and UE2 are (pre-) configured or indicated by higher layer signalling as a group for groupcast commination on a SL. UE_A is a COT initiator UE. UE1 and UE2 are COT shared UEs. UE_A can share the COT to member UE1 and UE2.

UE_A initializes a COT with 4 ms duration in time domain (denoted as Time slot #0, Time slot #1, Time slot #2, and Time slot #3) and 3 interlaces, i.e., Interlace 1, Interlace 3, Interlace 4. That is, Interlace 0 and Interlace 2 are not used by UE_A, UE1, and UE2. UE_A performs SL transmission on Interlaces 1, 3, and 4 in Time slot #0. UE_A further indicates the remaining channel occupancy duration=3 ms (i.e., Time slot #1, Time slot #2, and Time slot #3), e.g., in SCI.

A total number of member UEs is 2, i.e., M=2. M_ID for member UE1 is m=1. M_ID for member UE2 is m=2. The M_ID can be (pre-) configured or indicated by higher layer signalling.

The embodiments of FIG. 3 assume that parameters in Equation (1) are configured as follows. The j_interlace=3, i.e., each member UE can share 3 interlaces for a transmission for each time. The transmission for each time of each member UE can be allocated one or more time slots. The i_slot=1, i.e., each member UE can share 1 time slot at most. The j_interlace and/or i_slot can be (pre-) configured or indicated by higher layer signalling or can be further included in SCI from UE_A.

The frequency resource(s) of UEL and UE2 (i.e., interlaces(s)) can be determined based on the “frequency resource assignment” in SCI from UE_A and j_interlace. The time domain resource(s) of UE1 and UE2 (i.e., time slot(s)) can be determined based on “remaining channel occupancy duration” (i.e., 3 ms) in SCI from UE_A and i_slot.

Here, “frequency resource assignment” indicates that 3 interlaces are used by UE_A, and j_interlace=3. Thus, UE1 and UE2 will use 3 interlaces for a transmission for each time in their transmission slot(s). The transmission for each time of UE1 and UE2 can be allocated one or more time slots. “Remaining channel occupancy duration” is 3 (i.e., Time slot #1, Time slot #2, and Time slot #3) and i_slot=1. Following Equation (1) defined above, UE1 may determine to use Interlaces 1, 3, and 4 and Time slot #1 for its transmission based on its member ID (i.e., M_ID), i.e., m=1. UE2 may determine to use interlaces 1, 3, and 4 and Time slot #2 for its transmission based on its member ID, i.e., m=2.

More specifically, as shown in FIG. 3, interlaces within remaining channel occupancy duration of the COT (i.e., Time slot #1, Time slot #2, and Time slot #3) can be shared to UE1 and UE2. Resource indexes corresponding to all interlaces within these time slots include: resource indexes 1, 2, and 3 in Time slot #1, resource indexes 4, 5, and 6 in Time slot #2, and resource indexes 7, 8, and 9 in Time slot #3.

When i_slot=1, UE1 and UE 2 can share 1 time slot at most. For UE1, since m=1, M=2, i_slot=1, and j_interlace=3, following Equation (1) defined above, j= [1, 3]. That is, frequency resources that can be used by UE1 within remaining channel occupancy duration of the COT are interlaces with resource indexes 1, 2, and 3 in Time slot #1. For UE2, since m=2, M=2, i_slot=1, and j_interlace=3, following Equation (1) defined above, j=[4, 6]. That is, frequency resources that can be used by UE2 within remaining channel occupancy duration of the COT are interlaces with resource indexes 4, 5, and 6 in Time slot #2.

FIG. 4 illustrates exemplary sidelink transmissions in a COT in accordance with some embodiments of the present disclosure. The same as FIG. 3, the embodiments of FIG. 4 refer to 5 interlaces (denoted as Interlace 0 to Interlace 4) in frequency domain. As shown in FIG. 4, UE_A, eight member UEs (i.e., UE1 to UE8) are (pre-) configured or indicated by higher layer signalling as a group for groupcast commination on a SL. UE_A is a COT initiator UE. UE1 to UE8 are COT shared UEs. UE_A performs SL transmission on interlaces 1, 3, and 4 in both Time slot #0 and Time slot #1. UE_A can share the COT to member UE1 to UE8. The embodiments of FIG. 4 assume that interlaces in frequency domain are assigned to UEs. Other embodiments of FIG. 4 may refer to other type of resources (e.g., PRB(s) or subchannel(s)), without departing from the spirit and scope of the disclosure. Details described in all of other embodiments of the present disclosure are applicable for the embodiments shown in FIG. 4.

UE_A initializes a COT with 6 ms duration in time domain (denoted as Time slot #1 to Time slot #5) and 3 interlaces, i.e., Interlace 1, Interlace 3, Interlace 4. That is, Interlace 0 and Interlace 2 are not used by UE_A and UE1 to UE8. UE_A further indicates the remaining channel occupancy duration=4 ms (i.e., Time slot #2, and Time slot #3, Time slot #4, Time slot #5), e.g., in SCI.

A total number of member UEs is 8, i.e., M=8. M_ID for each of member UE1 to UE8 is m=1, m=2, m=3, m=4, m=5, m=6, m=7, and m=8, respectively. The M_ID can be (pre-) configured or indicated by higher layer signalling to each member UE.

The embodiments of FIG. 4 assume that parameters in Equation (1) are configured as follows. The j_interlace=1, i.e., each member UE can share 1 interlace for a transmission for each time. The transmission for each time of each member UE can be allocated one or more time slots. The i_slot=2, i.e., each member UE can share 2 time slots at most. The j_interlace and/or i_slot can be (pre-) configured or indicated by higher layer signalling or can be further included in SCI from UE_A.

The frequency resource(s) of UE1 to UE8 (i.e., interlaces(s)) can be determined based on the “frequency resource assignment” in SCI from UE_A and j_interlace. The time domain resource(s) of UE1 to UE8 (i.e., time slot(s)) can be determined based on “remaining channel occupancy duration” (i.e., 4 ms) in SCI from UE_A and i_slot.

Here, “frequency resource assignment” indicates that 3 interlaces are used by UE_A, and j_interlace=1. Thus, UE1 to UE8 will use 1 interlace in their transmission slot. “Remaining channel occupancy duration” is 4 (i.e., Time slot #2, Time slot #3, Time slot #4, and Time slot5 #) and i_slot=2. Following Equation (1) defined above, UE1 may determine to use Interlace 1 and Time slot #2 for its transmission based on its member ID (i.e., M_ID), i.e., m=1. UE 2 may determine to use Interlace 3 and Time slot #3 for its transmission based on its member ID, i.e., m=2, and so on. Due to i_slot=2, each UE in UE1 to UE8 can share 2 time slots at most. For example, UE1 may determine to use Interlace 4 and Time slot #4 for its transmission based on its member ID, i.e., m=1.

More specifically, as shown in FIG. 4, frequency resources (i.e., interlaces) within remaining channel occupancy duration of the COT (i.e., Time slot #2 to Time slot #5) can be shared to UE1 to UE8. Resource indexes corresponding to all interlaces within these four time slots include: resource indexes 1, 2, and 3 in Time slot #2; resource indexes 4, 5, and 6 in Time slot #3; resource indexes 7, 8, and 9 in Time slot #4; and resource indexes 10, 11, and 12 in Time slot #5.

When i_slot=2, UE1 to UE 8 can share 2 time slots at most. For UE1, since m=1, M=8, and j_interlace=1, following Equation (1) defined above, when i_slot=1, j=[1, 1], and when i_slot=2, j=[9, 9]. That is, frequency resources that can be used by UE1 within remaining channel occupancy duration of the COT include: interlace with resource index 1 in Time slot #2 for a transmission for the first time; and interlace with resource index 9 in Time slot #4 for a transmission for the second time. For UE2, since m=2, M=2, and j_interlace=3, following Equation (1) defined above, when i_slot=1, j=[3, 3], and when i_slot=2, j=[10, 10]. That is, frequency resources that can be used by UE2 within remaining channel occupancy duration of the COT are: interlace with resource index 3 in Time slot #2 for a transmission for the first time; and interlace with resource index 10 in Time slot #5 for a transmission for the second time. UE3 to UE8 are in a similar manner to UE1 and UE2.

In the embodiments of FIG. 4, if there is no enough resource in the shared COT, the UE without shared resource will not perform any transmission. As described above, the maximum resource index is 12 (i.e., 3 interlaces per slot*4 time slots of the remaining channel occupancy duration). For example, for UE8, since m=8, M=8, and j_interlace=1, following Equation (1) defined above, when i_slot=1,j=[8, 8], and when i_slot=2, j=[16, 16]. That is, a frequency resource that can be used by UE8 within remaining channel occupancy duration of the COT is interlace with resource index 8 in Time slot #4 for a transmission for the first time. Since interlace with resource index 16 is greater than the maximum resource index 12, there is no frequency resource for a transmission for the second time of UE8. Similarly, all of UE5, UE6, UE7 and UE8 have no shared resource for their transmission(s) of the second time, due to the resource index calculated via Equation (1) is greater than the maximum resource index, i.e., 12. That is, UE1 to UE4 have their transmission(s) for the second time, i.e., in Time slot #4 and Time slot #5. UE5 to UE8 only have their transmission(s) for the first time, i.e., in Time slot #3 and Time slot #4.

According to some embodiments of the present disclosure, if a member UE, e.g., UE1 has no data for groupcast transmission on a sidelink, UE_A may know it based on previous higher layer information exchanging, e.g., BSR information, ID information of the member UE(s) in the groupcast group, or a total number of the member UE(s) in the groupcast group. The initialized COT without data may be lost by the other UE or Wi-Fi system. Embodiments of FIGS. 5-7 aim to provide solutions to solve this issue in such scenarios.

FIGS. 5-7 illustrate exemplary sidelink transmissions in a COT in accordance with some embodiments of the present disclosure. The same as FIG. 3, the embodiments of FIGS. 5-7 refer to 5 interlaces (denoted as Interlace 0 to Interlace 4) in frequency domain. UE_A initializes a COT with 4 ms duration in time domain (denoted as Time slot #0, Time slot #1, Time slot #2, and Time slot #3) and 3 interlaces, i.e., Interlace 1, Interlace 3, Interlace 4. UE_A further indicates the remaining channel occupancy duration=3 ms (i.e., Time slot #1, Time slot #2, and Time slot #3), e.g., in SCI. The embodiments of FIGS. 5-7 assume that interlaces in frequency domain are assigned to UEs. Other embodiments of FIGS. 5-7 may refer to other type of resources (e.g., PRB(s) or subchannel(s)), without departing from the spirit and scope of the disclosure. Details described in all of other embodiments of the present disclosure are applicable for the embodiments shown in FIGS. 5-7.

In the embodiments of FIG. 5, if UE_A may know that a time slot (e.g., Time slot #1 as shown in FIG. 5) includes no data for groupcast transmission, for example, based on previous higher layer information exchanging (e.g., BSR information, ID information in the groupcast group, and/or a total number of the member UE(s) in the groupcast group) of member UE(s). Then, UE_A may transmit reservation signalling or transmission on the time slot without data transmission. The reservation signalling or transmission can use at least one of indicated interlaces, i.e., at least one of Interlaces 1, 3, and 4. As shown in FIG. 5, UE_A transmits a reservation transmission on Interlace 1 (which is with resource index 1 among all indexes 1 to 6) in Time slot #1, such that the initialized COT is not lost by a member UE or Wi-Fi system. In some other embodiments, UE_A may transmit reservation transmissions on Interlaces 1 and 3, Interlaces 1 and 4, Interlaces 3 and 4, or Interlaces 1, 3, and 4.

In the embodiments of FIG. 6, UE_A can perform short sensing to detect a potential transmission at the beginning of each time slot within remaining channel occupancy duration of the COT, if the channel is available. If UE_A detects that a time slot includes no transmission, UE_A may transmit a reservation signalling or transmission on the time slot without data transmission.

For instance, a gap symbol (e.g., duration #1 in Time slot #1 as shown in FIG. 6) and subsequent symbols in this time slot are used for the potential data transmission from a member UE. The gap symbol is also used for the sensing at a COT initiator UE. The COT initiator UE will perform sensing on the gap symbol, and then determine whether to perform a transmission on subsequent symbols in this time slot. If no data transmission is detected on the gap symbol (e.g, from a member UE), the COT initiator UE will perform transmission(s) on subsequent symbols in this time slot for keeping the COT. For example, the short sensing can be a type 2 LBT or 9 us duration. The reservation signalling or transmission can use at least one of indicated interlace, i.e., at least one of Interlace 1, 3, and 4. After performing transmission(s) on subsequent symbols in this time slot, the COT initiator UE may perform sensing on a gap symbol of a next time slot (e.g., duration #2 in Time slot #2 as shown in FIG. 6). In response to detecting any data transmission on the gap symbol (e.g, from a member UE), the COT initiator UE will not perform transmission(s) on subsequent symbols in the next time slot.

FIG. 7 illustrates exemplary sidelink transmissions in a COT in accordance with some embodiments of the present disclosure. In the embodiments of FIG. 7, UE_A may transmit an M_ID_offset indicator in SCI. A member UE, e.g., UE2, may determine its resource based on Equation (2):

$$j = [ ( ( m - M\_ID \_offset ) - 1 + M * ( i\_slot - 1 ) ) * j\_interlace + 1 , ( ( m - M\_ID \_offset ) + M * ( i\_slot - 1 ) ) * j\_interlace ] \qquad Equation ( 2 )$$

wherein:
   j is an index range of the set of resources for a UE;
   j_interlace is a maximum number of frequency resource(s) for a transmission for each time of the UE, and the transmission for each time of the UE can be allocated one or more time slots;
   i_slot is a maximum number of time slot(s) for the UE within remaining channel occupancy duration of the initialized COT, and 0<i_slot=<i;
   m is a (pre-) configured M_ID (member ID) index;
   M is a maximum total number of member UEs in the groupcast group; and
   M_ID_offset is an offset to the (pre-) configured M_ID index.

That is, Equation (2) is different from Equation (1) due to using an offset “M_ID_offset” to the (pre-) configured M_ID index “m”.

Similar to FIG. 5, in the embodiments of FIG. 7, UE_A may know that a time slot (e.g., Time slot #1 as shown in FIG. 7) includes no data for groupcast transmission, for example, based on previous higher layer information exchanging (e.g., BSR information, ID information of the member UE(s) in the groupcast group, and/or a total number of the member UE(s) in the groupcast group) with member UE(s). For instance, if UE_A knows that Time slot #1 includes no data, UE_A may transmit an M_ID_offset indicator in SCI with M_ID_offset=1. After receiving the M_ID_offset indicator, UE2 may determine an index range of the set of resources for UE2 via Equation (2). Thus, when m=1, M_ID_offset=1, M=2, i_slot=1, and j_interlace=3, following Equation (2) defined above, j=[1, 3]. That is, frequency resources that can be used by UE2 within remaining channel occupancy duration of the COT are interlaces with resource indexes 1, 2, and 3 in Time slot #1. In other words, interlaces in Time slot #2 is released by the groupcast group of UE_A, UE1 and UE2. By Equation (2) in the embodiments of FIG. 7, resource(s) not used by the groupcast group may be released.

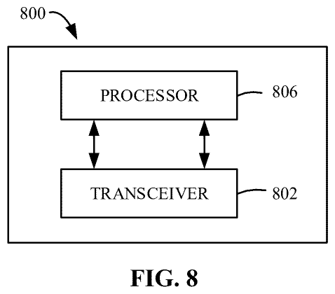

FIG. 8 illustrates a block diagram of an exemplary apparatus 800 in accordance with some embodiments of the present disclosure. As shown in FIG. 8, the apparatus 800 may include at least one processor 806 and at least one transceiver 802 coupled to the processor 806. The apparatus 800 may be a COT initiator UE or a COT shared UE.

Although in this figure, elements such as the at least one transceiver 802 and processor 806 are described in the singular, the plural is contemplated unless a limitation to the singular is explicitly stated. In some embodiments of the present application, the transceiver 802 may be divided into two devices, such as a receiving circuitry and a transmitting circuitry. In some embodiments of the present application, the apparatus 800 may further include an input device, a memory, and/or other components.

In some embodiments of the present application, the apparatus 800 may be a UE (a COT initiator UE, or a COT shared UE). The transceiver 802 and the processor 806 may interact with each other so as to perform the operations with respect to the UEs described above, for example, in FIGS. 1-7.

In some embodiments of the present application, the apparatus 800 may further include at least one non-transitory computer-readable medium. For example, in some embodiments of the present disclosure, the non-transitory computer-readable medium may have stored thereon computer-executable instructions to cause the processor 806 to implement the method with respect to the UEs as described above. For example, the computer-executable instructions, when executed, cause the processor 806 interacting with transceiver 802 to perform the operations with respect to the UEs described in FIGS. 1-7.

For example, in some embodiments of the present disclosure, the non-transitory computer-readable medium may have stored thereon computer-executable instructions to cause the processor 806 to implement the method with respect to the BSs as described above. For example, the computer-executable instructions, when executed, cause the processor 806 interacting with transceiver 802 to perform the operations with respect to the BSs described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
initialize a channel occupancy time (COT) corresponding to a channel access priority class (CAPC) level or a traffic priority level; and
transmit at least one of sidelink control information (SCI) or a data transmission associated with the SCI on a sidelink during a first channel occupancy duration of the COT, wherein the SCI includes frequency and time resource indication information.

2. The UE of claim 1, wherein the frequency and time resource indication information includes at least one of:
first information indicating one or more frequency resources assigned for the UE and one or more member UEs in a groupcast group, wherein the at least one of the SCI or the data transmission is transmitted on the one or more frequency resources;
second information indicating remaining channel occupancy duration of the COT for the one or more member UEs; and
third information indicating time duration of the COT and one or more time slots used by the UE within the time duration of the COT.

3. The UE of claim 2, wherein the first information includes one of:
one or more indexes of the one or more frequency resources;
a field in a bitmap associated with the one or more frequency resources;
a starting point and an ending point in a frequency domain associated with the one or more frequency resources; and
a starting point and a length in the frequency domain associated with the one or more frequency resources.

4. The UE of claim 1, wherein the SCI further includes at least one of:
a first indicator indicating a total number of one or more frequency resources that can be used by each member UE in a groupcast group within the time duration of the COT or a remaining channel occupancy duration of the COT; or
a second indicator indicating a total number of one or more time slots usable by each UE within the time duration of the COT or the remaining channel occupancy duration of the COT.

5. The UE of claim 1, wherein the at least one processor is further configured to cause the UE to exchange higher layer information with one or more member UEs in a groupcast group, wherein the higher layer information includes at least one of buffer status report (BSR) information, ID information of the one or more member UEs in the groupcast group, or a total number of the one or more member UEs in the groupcast group.

6. The UE of claim 5, wherein the at least one processor is further configured to cause the UE to:
determine, based on the higher layer information, whether a first time slot within the time duration of the COT or the remaining channel occupancy duration of the COT includes no data transmission from the one or more member UEs; and
transmit a reservation transmission in the first time slot, in response to determining that the first time slot includes no data transmission from the one or more member UEs.

7. The UE of claim 1, wherein the at least one processor is further configured to cause the UE to:
perform a sensing operation to detect a transmission at a second time slot within a time duration of the COT or a remaining channel occupancy duration of the COT; and
transmit a reservation transmission in the second time slot, in response to detecting that the second time slot includes no transmission.

8. The UE of claim 7, wherein the sensing operation is performed on a first time duration at a beginning of the second time slot, and wherein the reservation transmission is transmitted on a subsequent time duration within the second time slot.

9. A first user equipment (UE) for wireless communication, comprising:
at least one memory; and
at least one processor coupled with the at least one memory and configured to cause the first UE to:
receive at least one of sidelink control information (SCI) or a data transmission associated with the SCI on a sidelink during a first channel occupancy duration of a channel occupancy time (COT),
wherein the SCI includes frequency and time resource indication information, and
wherein the COT corresponds to a channel access priority class (CAPC) level or a traffic priority level and is initiated by a second UE.

10. The first UE of claim 9, wherein the frequency and time resource indication information includes at least one of:
first information indicating one or more frequency resources assigned for the second UE and one or more member UEs in a groupcast group, wherein the one or more member UEs include the first UE, and wherein the at least one of the SCI or the data transmission is transmitted on the one or more frequency resources;
second information indicating a remaining channel occupancy duration of the COT for the one or more member UEs; and
third information indicating a time duration of the COT and one or more time slots used by the UE within the time duration of the COT.

11. The first UE of claim 10, wherein the first information includes one of:
one or more indexes of the one or more frequency resources;
a field in a bitmap associated with the one or more frequency resources;
a starting point and an ending point in a frequency domain associated with the one or more frequency resources; and
a starting point and a length in the frequency domain associated with the one or more frequency resources.

12. The first UE of claim 10, wherein the at least one processor is further configured to cause the first UE to: allocate a resource index to each of the one or more frequency resources within the time duration of the COT or the remaining channel occupancy duration of the COT.

13. The first UE of claim 9, wherein the at least one processor is further configured to cause the first UE to receive at least one of:
a first indicator indicating a total number of one or more frequency resources usable by each UE in a groupcast group within the time duration of the COT or the remaining channel occupancy duration of the COT; or
a second indicator indicating a total number of one or more time slots that usable by each UE within the time duration of the COT or the remaining channel occupancy duration of the COT.

14. The first UE of claim 13, wherein the at least one processor is further configured to cause the first UE to: determine a set of resources to be used by the first UE within the time duration of the COT or the remaining channel occupancy duration of the COT based on a set of parameters, and wherein the set of parameters include at least one of:
a member ID of the first UE;
a total number of one or more member UEs in a groupcast group;
the first indicator; or
the second indicator.

15. A method performed by a user equipment (UE), the method comprising:
initializing a channel occupancy time (COT) corresponding to a channel access priority class (CAPC) level or a traffic priority level; and
transmitting at least one of sidelink control information (SCI) or a data transmission associated with the SCI on a sidelink during a first channel occupancy duration of the COT, wherein the SCI includes frequency and time resource indication information.

16. A processor for wireless communication, comprising:
at least one controller coupled with at least one memory and configured to cause the processor to:
initialize a channel occupancy time (COT) corresponding to a channel access priority class (CAPC) level or a traffic priority level; and
transmit at least one of sidelink control information (SCI) or a data transmission associated with the SCI on a sidelink during a first channel occupancy duration of the COT, wherein the SCI includes frequency and time resource indication information.

17. The processor of claim 16, wherein the frequency and time resource indication information includes at least one of:
first information indicating one or more frequency resources assigned for the processor and one or more member UEs in a groupcast group, wherein the at least one of the SCI or the data transmission is transmitted on the one or more frequency resources;
second information indicating remaining channel occupancy duration of the COT for the one or more member UEs; and
third information indicating time duration of the COT and one or more time slots used by the processor within the time duration of the COT.

18. The processor of claim 17, wherein the first information includes one of:
one or more indexes of the one or more frequency resources;
a field in a bitmap associated with the one or more frequency resources;
a starting point and an ending point in a frequency domain associated with the one or more frequency resources; and
a starting point and a length in the frequency domain associated with the one or more frequency resources.

19. The processor of claim 16, wherein the SCI further includes at least one of:
a first indicator indicating a total number of one or more frequency resources that can be used by each member UE in a groupcast group within the time duration of the COT or a remaining channel occupancy duration of the COT; or
a second indicator indicating a total number of one or more time slots usable by each UE within the time duration of the COT or the remaining channel occupancy duration of the COT.

20. The processor of claim 16, wherein the at least one controller is further configured to cause the processor to exchange higher layer information with one or more member UEs in a groupcast group, wherein the higher layer information includes at least one of buffer status report (BSR) information, ID information of the one or more member UEs in the groupcast group, or a total number of the one or more member UEs in the groupcast group.
